(19) United States
(12) Patent Application Publication
(10) Pub. No.: US 2009/0210701 A1
(43) Pub. Date: Aug. 20, 2009

(54) Multi-Media Access Device Registration System and Method

(76) Inventors: Junbiao Zhang, Bridgewater, NJ (US); Kumar Ramaswamy, Princeton, NJ (US); Jeffrey Allen Cooper, Rocky Hill, NJ (US)

Correspondence Address: Thomson Licensing LLC, P.O. Box 5312, Two Independence Way, PRINCETON, NJ, 08543-5312, US

(21) Appl. No.: 11/921,424

(22) PCT Filed: Jun. 23, 2005
(86) PCT No.: PCT/US2005/022340

§ 371 Date: Nov. 30, 2007

(51) Int. Cl. H04L 9/32; H04L 9/08; H04L 29/06

(52) U.S. Cl. 713/156; 713/171; 380/285

(57) ABSTRACT

A method for enabling an access device to securely access content from at least a content provider and prevent a cloned access device from accessing such content. During registration of the access device with the content provider, the access device requests from a designated certificate authority a certificate having a public key of the content provider therein. Upon authentication of the certificate, the access device generates a key and uses the public key to exchange the key with the content provider. The key is then used for subsequent secure communications between the access device and the content provider. In this manner, a cloned device does not have access to the key and is unable to download content from the content provider.

### BACKGROUND OF THE INVENTION

1. Field of the Invention

The present invention relates generally to content access devices, such as digital broadcast/cable/satellite receivers/decoders, and more particularly to methods and systems for activating and registering such devices. The registration may be performed within a context of subscription based service providers.

2. Related Art

High-value content (e.g, audio, video, and multimedia content) is often distributed via subscription-based services. Subscription based services may range from a single program to entire channels or groups of channels. A typical subscription-based content delivery system is digital video broadcasting (DVB). When a DVB receiver (one example of a set-top unit or set-top box) tunes a DVB service (such as a satellite, digital terrestrial or digital cable signal), it may conventionally physically tune a given transponder which carries many DVB services in a multiplexed Program Transport Stream (MPTS). An associated demultiplexer extracts, through digital filters, different data streams relating to the expected services. The DVB receiver then builds from these different data streams a Single Program Transport Stream (SPTS), and processes the streams for display using a television coupled to the DVB receiver/decoder, for example.

Failure to provide secure subscription access to content, such as that conventionally carried by a DVB network, may result in theft of system identifiers or users' credentials (e.g., credit card information). Failure to make the subscription convenient may limit consumer acceptance of the system. A failure to ensure proper subscription information may lead to consumer problems and/or unauthorized access to content. Furthermore, failure to prevent unauthorized access by cloned consumer devices may also lead to unauthorized access to content. Any or all of these conditions may lead to disruptions in service, customer dissatisfaction, and lost revenue for a service provider.

### BRIEF SUMMARY OF THE INVENTION

In view of the above, there is a need for a method and an apparatus that enables an access device to register to receive digital content from a content provider, in particular a subscription based content provider. The method and apparatus according to the present invention allow for registering of the access device with the content provider, and subsequent secure communication between them, while preventing cloned devices from also accessing the content from the content provider.

The invention provides a method for enabling an access device to securely access content from at least a content provider while preventing a cloned access device from accessing such content. During registration of the access device with the content provider, the access device requests from a designated certificate authority a certificate having a public key of the content provider therein. Upon authentication of the certificate, the access device generates a key and uses the public key to exchange the key with the content provider. The key is then used for subsequent secure communications between the access device and the content provider. In this manner, a cloned device does not have access to the key and is unable to download content from the content provider.

In this regard, the invention provides a method for enabling an access device to access content, including audio/video programs, from a content provider comprising: receiving a certificate associated with a particular content provider; authenticating the certificate and determining unique data associated with the particular content provider; generating a key for communicating with the particular content provider; encrypting the key in response to the unique data determined from the certificate and transmitting the encrypted key to the particular content provider; requesting content from the particular content provider; and decrypting content received from the particular content provider using the key.

The invention also provides an apparatus for communicating with a content provider, the apparatus, comprising: a port for communicating with a plurality of content providers; memory having a first key and executable code stored therein for controlling the operation of the apparatus; a signal output for coupling output signals to a display device; and processor coupled to the port, memory, and signal output, the processor operative to cause the apparatus to: transmit a request for a certificate from a certificate authority; authenticate the certificate received from the certificate authority and determine unique data associated with a particular content provider; encrypt a key using the unique data associated with the particular content provider; transmit a request for content to the particular content provider; and decrypt content received from the particular content provider using the key.

The invention also provides a method for enabling an access device to access digital content from a content provider comprising: receiving authentication information associated with a particular content provider; processing the authentication information and determining unique data associated with the particular content provider included within the authentication information; generating a key for communicating with the particular content provider; encrypting the key in response to the unique data determined from the certificate and transmitting the encrypted key to the particular content provider; requesting content from the particular content provider; and decrypting content received from the particular content provider using the key.

### BRIEF DESCRIPTION OF THE DRAWINGS

Understanding of the present invention will be facilitated by consideration of the following detailed description of the preferred embodiments described purely by way of non-limiting example and taken in conjunction with the accompanying drawings, wherein like numerals refer to like parts and:

FIG. 1 illustrates a block diagram of a system including several access devices communicatively coupled to a content provider according to an aspect of the present invention;

FIGS. 2-4 illustrate flow chart of operations according to aspects of the present invention;

FIG. 5 illustrates a user interface suitable for use with an access device according to an aspect of the present invention;

FIGS. 6-10 illustrate flow charts of operations according to aspects of the present invention;

FIG. 11 illustrates a block diagram of a set-top unit according to an aspect of the present invention; and,

FIGS. 12-13 illustrate a user interface suitable for use with an access device according to an aspect of the present invention.

### DETAILED DESCRIPTION

It is to be understood that the figures and descriptions of the present invention have been simplified to illustrate elements that are relevant for a clear understanding of the present invention, while eliminating, for purposes of clarity, many other elements found in typical set-top unit systems and methods of making and using the same. Those of ordinary skill in the art will recognize that other elements are desirable and/or required in order to implement the present invention. However, because these elements are well known in the art, a detailed discussion of such elements is not provided herein.

According to an aspect of the present invention, a system and method for providing secure subscription based services to access devices such as consumer set-top units, personal video recorders or other such digital terminal devices, may be provided. Such a system and method may serve to deter illegal cloning of the consumer devices, while offering a viable solution for providing high-value content (e.g., audio/video/multimedia content) in a networked environment.

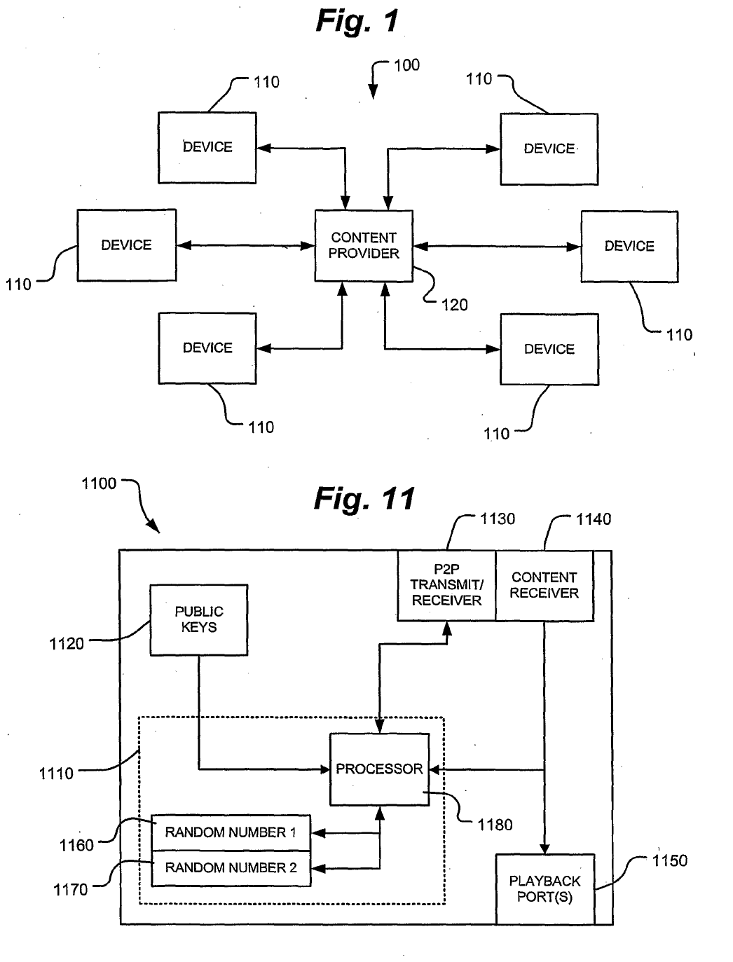

Referring now to FIG. 1, there is shown a block diagram of a system 100 according to an aspect of the present invention. System 100 includes a plurality of subscriber devices 110 communicatively coupled to a single content provider 120. One of ordinary skill in the art appreciates that many access devices 110 and several content providers 120 may comprise system 100. Further, any given device 110 may be communicatively coupled to one or more of the content providers 120.

A consumer who purchases or otherwise acquires an access device 110 generally registers the device, and subscribes to content offerings from content provider 120. Measures may be taken to frustrate unauthorized access to information sent between a subscribing device 110 and a content provider 120. Measures may also be taken to ensure that device requests for content from content provider 120 are authorized prior to fulfillment. Security codes may be automatically configured (rather than being user configurable) to mitigate the risk of these codes being used in connection with unauthorized devices. Cloning protection may be provided, such that if a access device 110 is cloned, attempted access by both the original and clone devices to content from content provider 120 using a single account may be prevented. A certificate based system and security key refreshing may also be employed according to the present invention. Key refreshing may be event based (e.g. content requests) and/or time-based (e.g. periodic key updates).

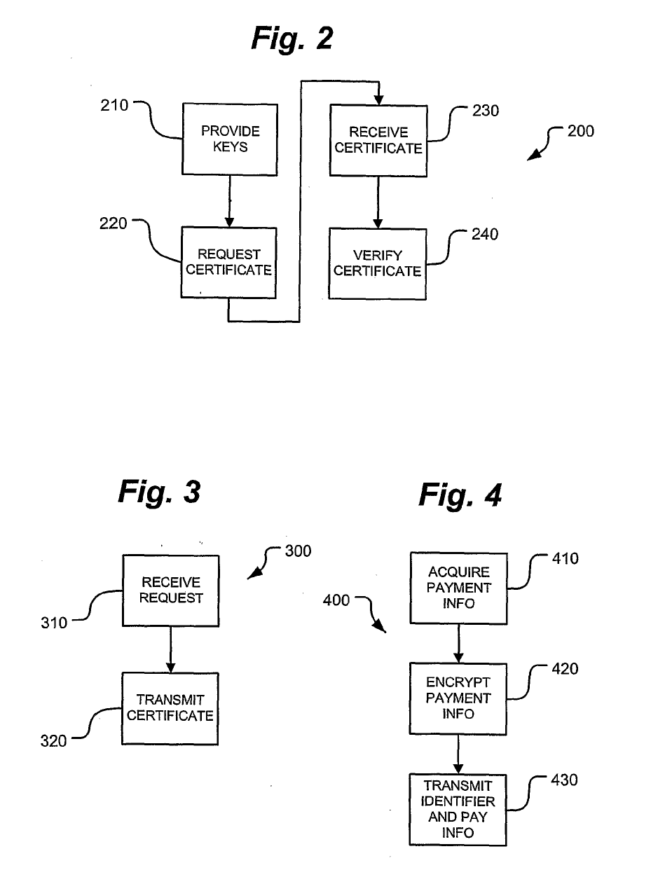

Referring now to FIG. 2, there is shown a process 200 for verifying or authenticating a service provider by the access device according to an aspect of the present invention. Prior to a consumer attempting to activate an access device 110, the device may be provided (block 210) with an electronic list of public keys, each key being associated with a particular certificate authority. In one configuration, the list is provided prior to a user activating the access device, that is, preloaded onto the access device. Present certificate authorities suitable for use with the present invention include Entrust and Verisign, for example. The public key list may be loaded into a memory of an access device 110 during device manufacture or at point of sale, for example. The public keys may be stored in an internal memory of the device, or on a replaceable memory device, such as a detachable memory stick or card, for example. As will be understood by those possessing an ordinary skill in the pertinent arts, since public keys are not secret, the stored list of keys need not be secure, though it may be. A separate memory card containing one or more certificate authority public keys may be provided separately to the user of a access device 110, or with the device itself.

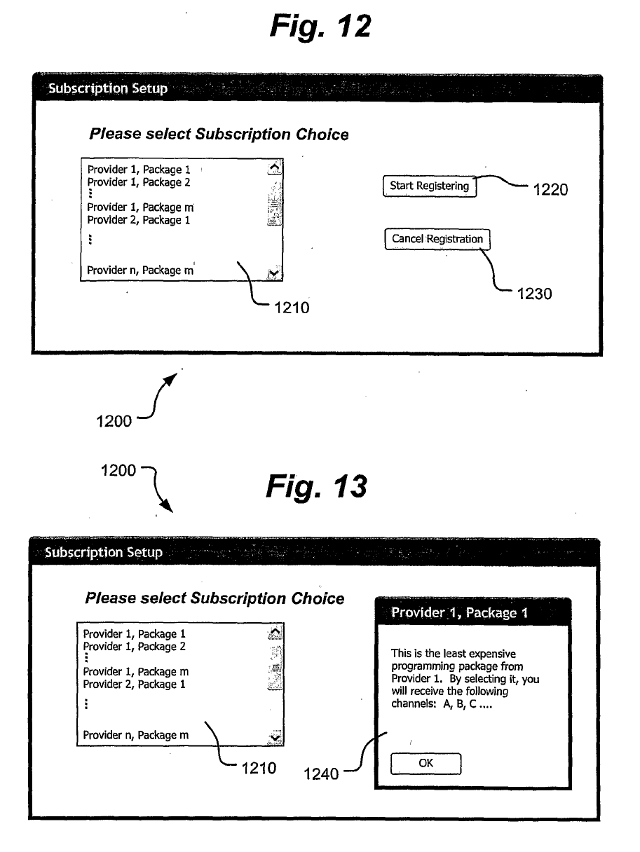

When a user acquires a access device 110, he may be advised to connect it to a display device, e.g., a television, a connection for receiving programming, such as satellite dish or cable, and a two-way communications network, such as a telephone line or direct subscriber line (DSL) or cable modem. In some cases, the connection for receiving the programs may serve as a two way communication network. Using the two-way communications network, the device 110 requests a certificate (block 220) from a selected content provider. An exemplary interface suitable for allowing a user to select a service provider is described in connection with FIGS. 12 and 13. Upon receiving the requested certificate (block 230), the device 110 authenticates the certificate (block 240), thereby ensuring that device 110 is communicating with the desired content provider.

Referring to FIG. 3 in conjunction with FIG. 2, upon a content provider 120 receiving the certificate request (block 310) transmitted (block 220) by a device 110, the content provider 120 transmits a certificate (block 320) to be received (block 230) by device 110.

For example, a certificate often takes the form of a file that is used for authentication purposes. A digital certificate may be issued to each content provider 120 by a Certificate Authority (CA). For example, a CA may use a CA private key Kpri to encrypt a digital certificate Cₛ containing a corresponding content provider's public key. A device 110 may contact a content provider 120, responsively to user selection of that content provider, to initiate a registration and subscription process by requesting certificate Cₛ via a two-way communications network. The communications network may support point-to-point communications between the device 110 and content provider 120.

As previously mentioned with respect to FIG. 2, upon receiving the certificate Cₛ (block 230), the requesting device 110 verifies the authenticity of the certificate (block 240) using a corresponding one of the stored CA public keys K_{pub}. Once a certificate is authenticated, the content provider's public key K_{pub} may be extracted from the decrypted certificate Cₛ and trusted as being authentic. This public key K_{pub} may be used to securely transmit information to the corresponding content provider 120, since the content provider's private key Kₚᵣᵢ is used to decrypt messages encrypted with K_{pub}.

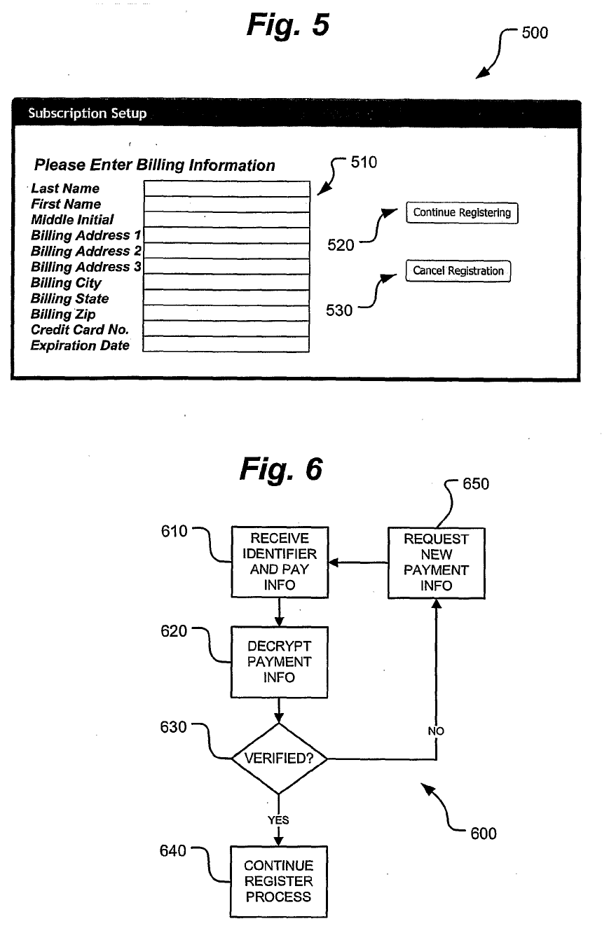

Referring now also to FIG. 4, process flow 400 illustrates that upon verifying the certificate at block 240 (FIG. 2), a device 110 acquires payment information (block 410), encrypts that information (block 420), and transmits the encrypted information (block 430) to an authenticated content provider 120. FIG. 5 shows an exemplary user interface 500 suitable for acquiring payment information from a registering user. Interface 500 may be displayed to a user via a display device coupled to device 110. Interface 500 includes data entry portions 510 that take the form of text boxes in the illustrated case, an accept portion 520 and a decline portion 530. Using a conventional interface, such as buttons on device 110 or a remote control associated with the device 110, a user may populate portions 510 to provide billing information to be associated with the content subscription. Upon activating accept portion 520, the payment information may be encrypted (block 420) and sent to a selected content provider 120 (block 430).

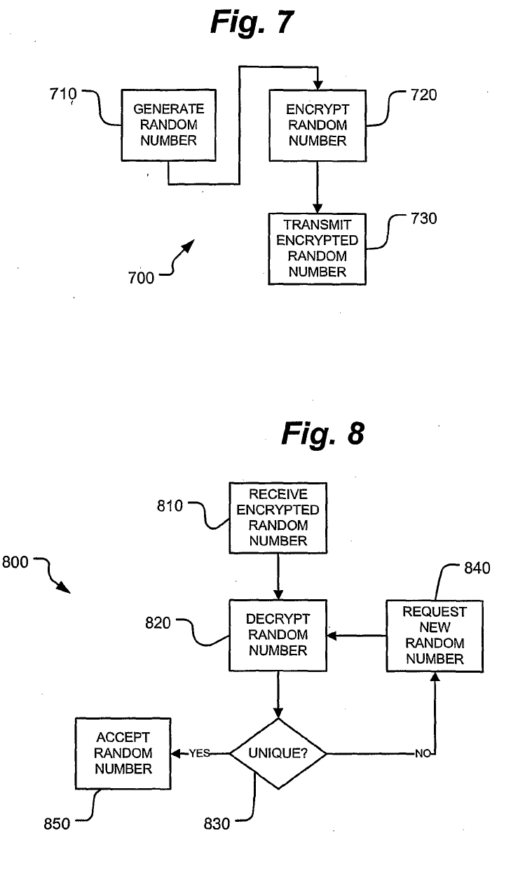

FIG. 6 shows a process 600 wherein content provider 120 receives (block 610) the transmitted payment information in addition to identifier information (e.g. serial number) of the device 110, and decrypts the payment information (block 620). Device 110 may then try to verify (block 630) the decrypted billing information. If the information is verified (block 630), the device may be permitted to proceed for registration (block 640). If the information is not able to be verified, a request for new billing information (block 650) may be sent to the transmitting device 110. In response, the transmitting device 110 may re-perform the operations associated with blocks 410, 420 and 430.

By way of further example, device 110 may encrypt the payment information using the extracted content provider public key K_{pub}, and content provider 120 may decrypt the received payment information using its private key Kₚᵣᵢ. Content provider 120 may then process the decrypted payment information, such as by submitting an initial charge to a credit card company dependently upon the decrypted payment information. Content provider 120 may notify the transmitting device 110 that the payment information has been verified or accepted. Content provider 120 may also store the verified payment information for effecting later charges associated with the subscription, if any should occur.

Alternatively, a user may establish a subscriber account (including exchanging payment information) with a content provider 120 separate from system 100. In such a case, a user may optionally simply enter account information to be transmitted to a selected content provider 120 into a device 110, such as an account number and personal identification number (PIN) to initiate key exchange, for example.

Referring now also to FIG. 7, there is shown a key generation and a transmission process 700 according to an aspect of the present invention. Once payment information has been verified or accepted, device 110 may generate a key (block 710) which may for example take the form of a random number generated by any suitable algorithm. In the illustrated operation, device 110 encrypts the random number (block 720), and transmits the encrypted number (block 730) to the content provider. The random number may be encrypted using the public key of the content provider. By way of further example, device 110 may receive an indication from the selected content provider 120 that payment information has been verified. Device 110 may then generate a pseudorandom number K_{d} (based on a system clock, serial number and/or device status, for example). The generated number K_{d} may then be encrypted with the content provider's public key K_{pub} (K_{pub}(K_{d})). The encrypted result may then be transmitted to the content provider.

Referring now also to FIG. 8, there is shown a process 800 according to an aspect of the present invention. Once the content provider 120 receives the encrypted random number (block 810) that was transmitted by a device 110 (block 730), the content provider 120 decrypts the number (block 820), determine if the number is sufficiently unique (block 830), and if so, accept the random number (block 850). If the content provider determines the number is not sufficiently unique (block 830), the content provider may request that the transmitting device 110 provide a new random number (block 840), thereby causing the device 110 to again perform the operations associated with blocks 710, 720 and 730. In response thereto, the content provider again receives the encrypted random number (block 810), decrypts it (block 820) and again determines whether it is sufficiently unique (block 830).

By way of further example only, a content provider 120 may decrypt a received random number K_{d} encrypted with its public key K_{pub} using its private key Kₚᵣᵢ. The content provider then checks the decrypted random number K_{d} to confirm there are no other sessions, or other devices, currently using the same K_{d}. If there are, the content provider 120 requests that the transmitting device 110 generate, encrypt and transmit another random number until a currently unused K_{d} is detected. Once a unique K_{d} is detected, the content provider accepts that K_{d} as the session key for the transmitting device, establishes a subscription account storing K_{d} in association with a device identifier, e.g., the serial number, and notifies the transmitting device of the acceptance. In response, the device 110 stores the key K_{d} in non-volatile, secure memory.

Subsequent secure communications between the transmitting device 110 and content provider 120 may be encrypted using K_{d} as a symmetric encryption/decryption key. For example, content requests sent from the transmitting access device 110 to content provider 120 may be encrypted using K_{d}, and content delivered form provider 120 to device 110 may be encrypted using K_{d}. In this manner, the key is generated and exchanged between the access device and the content provider during registration, and this key is used for subsequent secure communications between them. This method also prevents a cloned access device from receiving programs from the content provider since the cloned access device will not have the key for performing secure communications with the content provider.

For security reasons, and to frustrate unauthorized cloning efforts in particular, the shared secret key K_{d} may periodically be changed or refreshed. Alternatively, or additionally, a new key can be generated in response to each request for content access. Referring now also to FIG. 9, there is shown a key update process 900 according to an aspect of the present invention. A content provider 120 or device 110 determines (block 910) whether a shared key should be refreshed. If not, the device or provider may wait (block 940) until a refresh is desired. For example, the device 110 or content provider 120 may wait a given or predetermined temporal period, or until some triggering event is detected. In any event, when a refresh is desired (block 910), a new random number is generated and encrypted (block 920). The encrypted number is then be stored and transmitted to the other of the device 110 and content provider 120. As shown in FIG. 10, upon receiving the new random number (block 1010), the device 110 or provider 120 decrypts the new random number (block 1020) and stores the new random number in memory (block 1030). A confirmation message encrypted using the new number is sent to the transmitting device 110 or provider 120.

By way of further example only, according to an aspect of the present invention, a new key may be negotiated using the present key. For example, a new key K_{d+1} may be encrypted and sent to a corresponding access device 110 from a corresponding content provider 120 using a key K_{d} over a point-to-point communication channel. In this way, only one device 110 has access to the key K_{d+1}. Once content provider 120 is assured that key K_{d+1} has been received by the device 110 and decrypted, the content provider 120 and device 110 may make the previous key K_{d} inactive, and no longer accept or use it for transactions. Also, new key K_{d+1} may be generated using old key K_{d} as the seed value.

Subsequent communications between the transmitting device 110 and content provider 120 are encrypted using K_{d+1} as a symmetric encryption/decryption key. For example, content requests sent from the transmitting access device 110 to content provider 120 are encrypted using K_{d+1}, and content delivered form provider 120 to device 110 may be encrypted using K_{d+1}. Accordingly, even if device 110 is perfectly cloned, only one of the original and clone devices will be able to access restricted content, as the device that is not privy to the new key K_{d+1} will not have access to the present shared encryption key.

According to an aspect of the present invention, additional key(s), such as a key K_{c}, may be generated and sent to a device 110 by a content provider 120. This key(s) may be used to encrypt actual content, while the key K_{d} (or refreshed key K_{d+1}) is used for other secure communications (such as exchanging key K_{c}).

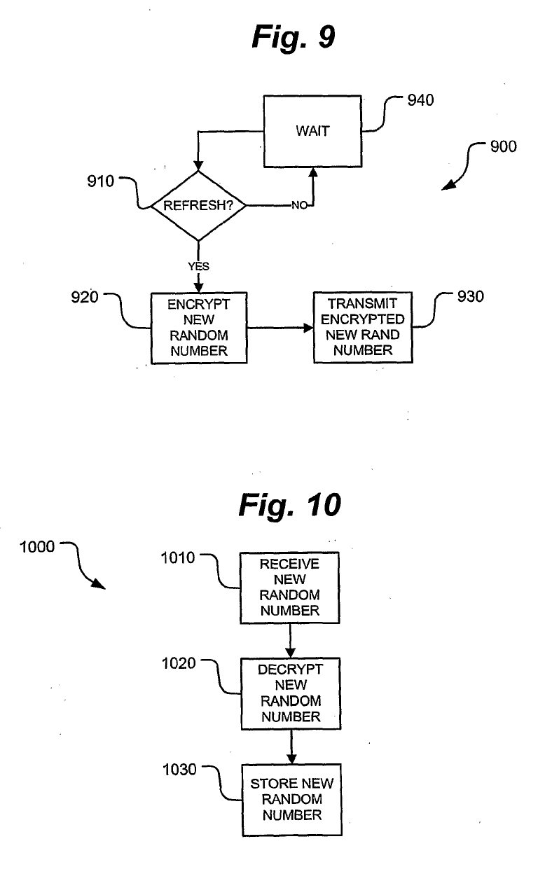

Referring now to FIG. 11, there is shown a block diagrammatic view of a system 1100 suitable for use with devices 110. System 1100 generally includes a secure processor and memory 1110, public key store 1120, point-to-point transceiver 1130, content receiver 1140 and playback port(s) 1150.

Secure processor 1110 may take the form of a smart-card, by way of non-limiting example only. Smart-card 1100 may include first and second memory locations 1160, 1170, for storing two random numbers (K_{d} and K_{d+1}, K_{d+1} and k_{d+2} . . . ). Smart card 1100 may also include secure memory location(s) for storing other keys, such as the aforementioned key K_{c}. The random number memories 1160, 1170 may take the form of a circular data buffer large enough to accommodate both keys and a flag indicating which key is the active key (either directly or indirectly). Smart card 1100 may further include a secure processor 1180.

“Memory”, as used herein, generally refers to one or more devices capable of storing data, such as in the form of chips, tapes or disks. Memory may take the form of one or more random-access memory (RAM), read-only memory (ROM), programmable read-only memory (PROM), erasable programmable read-only memory (EPROM), or electrically erasable programmable read-only memory (EEPROM) chips, by way of non-limiting example only. The memory utilized by the processor may be internal or external to an integrated unit including the processor. For example, in the case of a microprocessor, the memory may be internal or external to the microprocessor itself. “Processor”, as used herein, refers generally to a computing device including a Central Processing Unit (CPU), such as a microprocessor. A CPU generally includes an arithmetic logic unit (ALU), which performs arithmetic and logical operations, and a control unit, which extracts instructions (e.g., processor executable code) from memory and decodes and executes them, calling on the ALU when necessary. Of course, other elements may be used, such as an electronic interface or Application Specific Integrated Circuit (ASIC), for example.

Public key store 1120 may take the form of memory for storing the list of public keys used to authenticate a content provider's certificate. Again, CA public key store 1120 need not be secured as it merely contains publicly available CA keys, though it may be.

Transceiver 1130 may take the form of a modulator/demodulator (modem) for communicating via a public switched telephone network (PSTN), for example. Alternatively, transceiver 1130 may take the form of suitable hardware and/or software for communicating with a broadband gateway device, such as a DSL or cable modem—in turn coupled to the global interconnection of computers and computer networks commonly referred to as the Internet.

Receiver 1140 may take the form of suitable hardware/software for receiving content transmitted by content provider 120. Receiver 1140 may be suitable for receiving point-to-point transmissions or broadcast transmissions. Receiver 1140 may take the form of a satellite television signal receiver, a cable television receiver or suitable hardware and/or software for communicating with a broadband gateway device, such as a DSL or cable modem—in turn coupled to the global interconnection of computers and computer networks commonly referred to as the Internet, all by way of non-limiting example only.

Play port(s) 1150 may be suitable for providing received content to a display device, such as a television. In the case of encrypted content, the content may be decrypted or otherwise made suitable for display using processor 1180 of smart-card 1110. Port(s) 1150 may take the form of coaxial RF ports and associated hardware/software, signal component ports and associated hardware/software and/or a high density multimedia interface (HDMI) port and associated hardware/software, all by way of non-limiting example only.

Referring now to FIG. 12, there is shown a user interface 1200 according to an aspect of the present invention. Interface 1200 may be well suited for being displayed on a display device by a subscription device 110, to enable a user to select a content provider and subscription. Data and processor executable code for displaying interface 1200 (and/or interface 500) may be stored in memory of a device 110. Interface 1200 includes data entry device 1210, that takes the form of list-box in the illustrated case, an accept device 1120 and decline device 1130. User controls associated with the user interface device, such as buttons on device 110 or a remote control associated with the device 110, enables a user to select a content provider and subscription, using device 1210. Upon activating device 1220, that takes the form of a button in the illustrated example, information indicative of the selected subscription may be sent to a selected content provider to trigger the processes described herein. Upon activating device 1230, the subscription process may be cancelled. As shown in FIG. 13, information 1240 associated with a selected provider and package may also be displayed and acknowledged by a user prior to selection of device 1220 or 1230. Information 1240 and the programming choices provided by device 1210 may be pre-loaded into a memory of device 110, such as smart-card 1110 and updated using transceiver 1130 or receiver 1140, for example.

It will be apparent to those skilled in the art that various modifications and variations may be made in the apparatus and process of the present invention without departing from the spirit or scope of the invention. Thus, it is intended that the present invention cover the modification and variations of this invention provided they come within the scope of the appended claims and their equivalents.

What is claimed is:

1. A method for enabling an access device to access content, including audio/video programs, from a content provider comprising:
receiving a certificate associated with a particular content provider;
authenticating the certificate and determining unique data associated with the particular content provider;
generating a key for communicating with the particular content provider;
encrypting the key in response to the unique data determined from the certificate and transmitting the encrypted key to the particular content provider;
requesting content from the particular content provider; and
decrypting content received from the particular content provider using the key.

2. The method of claim 1, wherein the key is generated as a function of at least one of time, serial number of the subscriber device, and operating status of the subscriber device.

3. The method of claim 1, wherein the unique data associated with the particular content provider comprises a public key associated with the particular content provider, and the key is encrypted using the public key.

4. The method of claim 1, further comprising the step of receiving from the content provider a notification of whether the transmitted encrypted key is acceptable for use, and if an acceptance notification is received, decrypting content from the content provider using the key, and if a non acceptance notification is received, generating another key, encrypting the another key and transmitting the encrypted another key to the content provider, and repeating the process until the acceptance notification is received.

5. The method of claim 1, wherein the requesting step comprises encrypting the request using the key.

6. The method of claim 1, further comprising the steps of providing a list of content providers, receiving a user selection of a particular content provider, and transmitting a certificate request to a certificate authority.

7. The method of claim 1, wherein the certificate is a certificate issued by a trusted certificate authority, and the authenticating step comprises authenticating the certificate using a public key associated with the certificate authority key stored in the subscriber device.

8. The method of claim 1, further comprising the step of generating a second key, encrypting the second key using the key, and transmitting the encrypted second key to the particular content provider, and upon receiving an acceptance notification from the particular content provider with respect to the second key, using the second key to decrypt subsequent content received from the particular content provider.

9. The method of claim 8, wherein the second key is generated as a function of the key.

10. The method of claim 1, further comprising the steps of:
receiving payment information from a user;
encrypting the payment information using the key; and
transmitting the encrypted payment information to the particular content provider.

11. An apparatus for communicating with a content provider, the apparatus, comprising:
a port for communicating with a plurality of content providers;
memory having a first key and executable code stored therein for controlling the operation of the apparatus;
a signal output for coupling output signals to a display device; and
processor coupled to the port, memory, and signal output, the processor operative to cause the apparatus to: transmit a request for a certificate from a certificate authority; authenticate the certificate received from the certificate authority and determine unique data associated with a particular content provider; encrypt a key using the unique data associated with the particular content provider; transmit a request for content to the particular content provider; and decrypt content received from the particular content provider using the key.

12. The apparatus of claim 11, wherein the processor is operative to generate the key in response to successful authentication of the certificate.

13. The apparatus of claim 11, wherein the key is generated as a function of at least one of time, serial number associated with the apparatus, and operating status of the apparatus.

14. The apparatus of claim 11, wherein the unique data comprises a public key associated with the particular content provider.

15. The apparatus of claim 11, wherein the memory includes a list of content providers, and the processor is operative to display the list of content providers, receive a user selection of the particular content provider, and transmit a request for a certificate to the certificate authority, and the certificate is authenticated using a public key associated with the certificate authority.

16. The apparatus of claim 11, wherein the processor is operative to periodically generate a another key, encrypt the another key using the key, transmit the another key to the particular content provider, and upon receipt of an acceptance notification, use the another key to encrypt requests to the particular content provider and decrypt content received from the particular content provider.

17. The apparatus of claim 16, wherein the another key is generated as a function of the key.

18. A method for enabling an access device to access digital content from a content provider comprising:
receiving authentication information associated with a particular content provider;
processing the authentication information and determining unique data associated with the particular content provider included within the authentication information;
generating a key for communicating with the particular content provider;
encrypting the key in response to the unique data determined from the certificate and transmitting the encrypted key to the particular content provider;
requesting content from the particular content provider; and
decrypting content received from the particular content provider using the key.

19. The method according to claim 18, wherein the authentication comprises a certificate received from a designated certificate authority.

20. The method according to claim 19, wherein the processing step comprises authenticating the certificate using a public key associated with the certificate authority stored in a memory of the access device.
